(19) United States
(12) Patent Application Publication
(10) Pub. No.: US 2011/0238915 A1
(43) Pub. Date: Sep. 29, 2011

(54) STORAGE SYSTEM

(75) Inventor: Yasuhito KIKUCHI, Kawasaki (JP)

(73) Assignee: Fujitsu Limited, Kawasaki (JP)

(21) Appl. No.: 13/045,696

(22) Filed: Mar. 11, 2011

(30) Foreign Application Priority Data
Mar. 29, 2010 (JP) 2010-075556

(51) Int. Cl. G06F 12/08

(52) U.S. Cl. 711/118; 711/E12.038

(57) ABSTRACT

A switch device includes interfaces connected to a host, a first storage device, and a second storage device having a cache memory, and a processor executing receiving a copy command indicating to copy target data stored in the first storage device to the second storage device from the host, transmitting a reading out command indicating to read out the target data stored in the first storage device corresponding to the copy command, receiving the target data corresponding to the transmitted reading out command from the first storage device, and transmitting, to the second storage device, a writing command for writing the target data and release information indicating that the target data is releasable from the cache memory.

### CROSS-REFERENCE TO RELATED APPLICATION

This application is based upon and claims the benefit of priority of the prior Japanese Patent Application No. 2010-075556, filed on Mar. 29, 2010 the entire contents of which are incorporated herein by reference.

### FIELD

The embodiment disclosed herein relates to a storage system that includes a plurality of storage devices that stores data and a switching device that controls communication between the storage devices.

### BACKGROUND

A storage system includes a host, storage devices and a switching device that controls communication between the host and each of the storage devices and communication between the storage devices. The switching device receives a command or data from the host, and transmits the received command or the received data to an interested storage device among the storage devices. In addition, the switching device receives a response or data from each of the storage devices, and transmits the received response or data to the interested host.

The switching device may be a virtualization switch that has a function of virtualizing storage regions of the storage devices. The virtualization of the storage regions of the storage devices is a technique for virtualizing the storage sections of the storage devices in the network layer (switch layer) and providing the host with a virtual volume that does not depend on the types of the storage sections.

The storage system backs up data in order to prevent a loss of the data in some cases. For example, when the virtualization switch receives, from the host, an instruction to copy data from a virtual volume of a copy source to a virtual volume of a copy destination, the virtualization switch specifies storage sections corresponding to the virtual volumes, and copies the data from the storage section of the copy source to the storage section of the copy destination. In order for the virtualization switch to copy data in response to a request transmitted from the host, the virtualization switch transmits, to a copy destination storage device, a command to write the data.

In general, the storage devices each have a disk device that stores data; and a cache memory that temporarily stores data. In general, data is read from and written in the cache memory for a shorter time period than reading and writing of the data from and in the disk device. Thus, as the frequencies of reading and writing data from and in the cache memory are higher, it is more efficient to use the cache memory. However, the cache memory has a limitation. Thus, when the storage region of the cache memory is full of data, the storage device sequentially updates the cache memory so as to delete data in order from data updated at the earliest time in the cache memory and write the latest data in the cache memory.

Access from the virtualization switch to the copy destination storage device is performed in order to write data in the copy destination storage device regardless of whether or not the data is to be backed up. Thus, new data is sequentially stored in the cache memory. Therefore, data to be backed up is frequently stored in the cache memory that is frequently used to read and write data. As a result, the cache memory may not be efficiently used.

### SUMMARY

According to an aspect of the invention, a switch device includes a first interface for transmitting and receiving data, the first interface connected to a first storage device, a second interface for transmitting and receiving data, the second interface connected to a second storage device having a cache memory, a third interface for transmitting and receiving data, the third interface connected to an external device, and a processor executing receiving a copy command indicating to copy target data stored in the first storage device to the second storage device from the external device via the third interface, transmitting a reading out command indicating to read out the target data stored in the first storage device corresponding to the copy command via the first interface, receiving via the first interface the target data corresponding to the transmitted reading out command from the first storage device, and transmitting to the second storage device via the second interface a writing command for writing the target data and release information indicating that the target data is releasable from the cache memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage system according to the embodiment.

FIG. 2 is a functional block diagram illustrating the storage system according to the embodiment.

FIG. 3 is a diagram illustrating virtualization of storage.

FIG. 4 is a diagram illustrating a function of copying data between storage devices.

FIG. 5 is a flowchart of a copying process in which flag information is added to a write command.

FIG. 6 is a diagram illustrating an example of the write command when the flag information indicates “1”.

FIG. 7 is a diagram illustrating an example of the write command when the flag information indicates “0”.

FIG. 8 is a flowchart of a copying process in which an additional process command is added.

FIG. 9 is a diagram illustrating the additional command.

### DESCRIPTION OF EMBODIMENT

Hereinafter, preferred embodiment will be described in detail with reference to drawings.

A storage system according to the embodiment is described with reference to the accompanying drawings.

Storage System

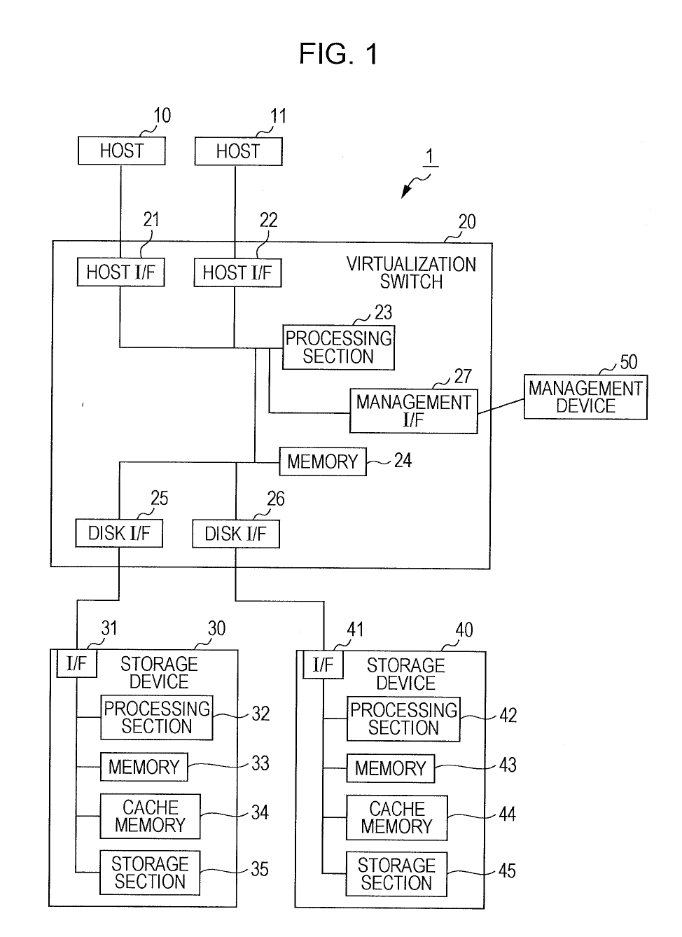

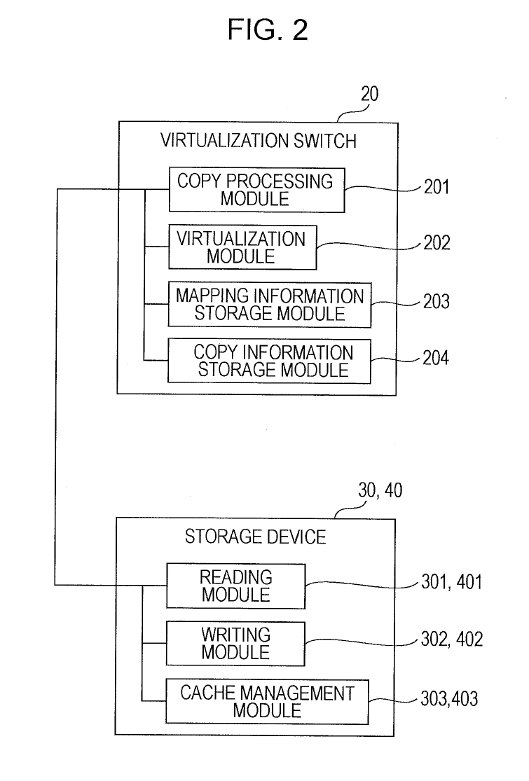

FIG. 1 illustrates the storage system according to the embodiment. FIG. 2 is a functional block diagram illustrating the storage system.

The storage system indicated by reference numeral 1 includes one or more hosts (upstream-side devices) 10, 11, a plurality of storage devices 30, 40 and a virtualization switch (switching device) 20.

Storage Devices

The storage system 1 includes the storage device 30 and the storage device 40.

The storage device 30 includes an interface (I/F) 31, a processing section 32, a memory 33, a cache memory 34 and a storage section 35.

The storage device 30 receives a write command from the virtualization switch 20 through the interface 31 and stores data in the storage section 35 according to the write command. The storage device 30 receives a read command from the virtualization switch 20 through the interface 31, reads data from the storage section 35 according to the read command, and transmits the read data to the virtualization switch 20.

Information is transferred between the storage device 30 and the virtualization switch 20 through the interface 31. The storage device 30 and the virtualization switch 20 are connected to each other through a fibre channel, for example.

The memory 33 stores information that uses for the processing section 32 to control the storage device 30. For example, the memory 33 stores processing programs such as a processing program to be used by the processing section 32 to execute processing (reading processing) of reading data stored in the storage section 35 or data stored in the cache memory 34, and a processing program to be used by the processing section 32 to execute processing (writing processing) of writing data in the storage section 35 or the cache memory 34. In addition, for example, the memory 33 stores information that uses for the processing section 32 to execute the reading processing and the writing processing.

The cache memory 34 is a storage region in which information to be stored in the storage section 35 is temporarily stored. The time period for reading data from the cache memory 34 is shorter than the time period for reading the data from the storage section 35, while the time period for writing data in the cache memory 34 is shorter than the time period for writing the data in the storage section 35. When the cache memory 34 is efficiently used, data reading performance and data writing performance of the storage device 30 are improved. It is preferable that data that may be read according to a read command more frequently than other data, or data that may be written according to a write command more frequently than other data, be stored in the cache memory 34 included in the storage device 30.

The storage section 35 is a storage region of a physical disk included in a disk device that is managed by the storage device 30. The storage section 35 is, for example, a single disk device. The disk device includes the physical disk, for example. Data can be read from and written in the physical disk. Multiple storage sections 35 may be combined so as to form a redundant arrays of independent disks (RAID). The storage device 30 may include a single storage section 35 as a single storage region (logical volume). In addition, the storage device 30 may include multiple single storage sections 35 as a single storage region (logical volume).

The storage device 30 manages information on the address of the logical volume managed by the storage device 30 and information on the address of the storage section 35, while the information on the address of the logical volume is associated with the information on the address of the storage section 35. The storage device 30 may manage a plurality of logical volumes. When the storage device 30 manages the plurality of logical volumes, the storage device 30 has information that identifies the logical volumes. In the following description, it is assumed that the address of the storage section 35 corresponds to the address of the logical volume.

The storage device 30 manages the inside of the storage section 35 using addresses. The addresses are assigned to blocks, respectively, while the blocks are the units in which data is stored.

In the following description, the storage device 30 writes data in the storage section 35, while the writing of the data in the storage section 35 indicates writing of the data in the storage region of the physical disk included in the storage section 35 that corresponds to the logical volume; the storage device 40 writes data in a storage section 45, while the writing of the data in the storage section 45 indicates writing of the data in a storage region of a physical disk included in the storage section 45 that corresponds to a logical volume; the storage device 30 reads data from the storage section 35, while the reading of the data from the storage section 35 indicates reading of the data from the storage region of the physical disk included in the storage section 35 that corresponds to the logical volume; and the storage device 40 reads data from the storage section 45, while the reading of the data from the storage section 45 indicates reading of the data from the storage region of the physical disk included in the storage section 45 that corresponds to the logical volume.

The processing section 32 controls the entire storage device 30. The processing section 32 functions as a reading module 301, a writing module 302 and a cache management module 303. The reading module 301 executes the reading processing according to the processing program stored in the memory 33. The writing module 302 executes the writing processing according to the processing program stored in the memory 33. The cache management module 303 manages the cache memory 34.

The functions of the processing section 32 are described with reference to FIG. 2 that is a functional block diagram illustrating the storage system.

First, the functional blocks of the storage device 30 are described below.

When the storage device 30 receives a read command from the virtualization switch 20, the reading module 301 reads, from the storage section 35, data corresponding to the read command, and transmits the read data to the virtualization switch 20. The reading module 301 causes the data (read from the storage section 35 and corresponding to the read command) to be stored in the cache memory 34, when necessary.

When the storage device 30 receives a write command from the virtualization switch 20, the writing module 302 causes data corresponding to the write command to be stored in the storage section 35. In this case, the writing module 302 causes the data corresponding to the write command to be stored in the cache memory 34, when necessary.

The cache management module 303 manages data to be stored so that data that may be read and written more frequently than the other data is stored in a storage region of the cache memory 34. For example, when the storage device 30 receives, from the virtualization switch 20, a write command that includes information indicating that the read data is to be copied, the cache management module 303 causes the data (to be copied) to be stored in the cache memory 34. The cache management module 303 reduces a priority for storing, in the cache memory 304, the data to be copied so that the priority is lower than a priority for storing other data stored in the cache memory 34. The cache management module 303 deletes data with a low priority from the cache memory 34 on a priority basis in order to update data stored in the cache memory 34.

The cache management module 303 is capable of storing, in the storage section 35, data (to be copied according to a copy command (described later)) with a lower priority than a priority set to the other data stored in the cache memory 34 without storing, in the cache memory, the data to be copied. The cache management module 303 substantially reduces the priority for storing the data (to be copied) in the cache memory 34 by performing the aforementioned processing.

The cache management module 303 uses a Least Recently Used (LRU) algorithm in order to determine data that is to be deleted from the cache memory 34, for example. According to the LRU algorithm, data that has not been used is deleted. Specifically, according to the LRU algorithm, data used at the earliest time is determined as data that will not be used. Then, the determined data is deleted according to the LRU algorithm.

For example, when data to be written in the cache memory 34 is to be copied and backed up, the storage device 30 treats the data as data that is not used at the time of writing the data in the cache memory 34. As a result, the storage device 30 can delete the data (to be copied) from the cache memory 34 on a priority basis.

In addition, the cache management module 303 can determine whether or not data needs to be stored in the cache memory 34. Only when the cache management module 303 determines that the data needs to be stored in the cache memory 34, the cache management module 303 causes the data to be stored in the cache memory 34. Furthermore, when the cache management module 303 detects data that does not need to be stored in the cache memory 34, the cache management module 303 can delete the data from the cache memory 34 on a priority basis. For example, when data that does not need to be stored in the cache memory 34 is written in the cache memory 34 and other data needs to be stored in the cache memory 34 after writing of the unnecessary data, the cache management module 303 selects the written unnecessary data as data to be deleted from the cache memory 34.

In an example of the embodiment, the cache management module 303 determines, on the basis of flag information included in a write command received by the storage device 30, whether or not the received write command indicates information that is to be stored in the cache memory 34.

In another example of the embodiment, the cache management module 303 specifies an additional processing command in the storage system 1. The additional processing command includes information that specifies a storage region range. When any of storage devices receives a write command that is related to data corresponding to the storage region range specified by the additional processing command, the additional processing command instructs the storage device to perform a process of reducing a priority for storing the data in the cache memory of the storage device or instructs the storage device not to store the data in the cache memory of the storage device.

In the embodiment, when the storage device receives an additional processing command and receives a write command concerning a storage region range specified by the additional processing command after the reception of the additional processing command, the storage device stores data (to be written) in the storage section without storing the data (to be written) in the cache memory or reduces a priority for storing the data in the cache memory when the data is stored in the cache memory.

Further, when the storage device receives the additional processing command and receives a read command concerning a storage region range specified by the additional processing command after the reception of the additional processing command, the storage device may stores data (to be read) in the storage section without storing the data (to be read) in the cache memory or reduces a priority for storing the data in the cache memory when the data is stored in the cache memory.

When the storage device 30 receives the additional processing command and receives the write command after the reception of the additional processing command, the cache management module 303 determines whether or not a storage region that is indicated by the received write command and in which the data is to be written is included in the storage region range specified by the additional processing command. When the storage region that is indicated by the received write command and in which the data is to be written is included in the storage region range specified by the additional processing command, the storage device 30 performs a process of preventing the data to be written from being stored in the cache memory 34 or performs another process.

An interface (I/F) 41, a processing section 42, a memory 43, a cache memory 44 and a storage section 45, which are included in the storage device 40, correspond to the interface (I/F) 31, the processing section 32, the memory 33, the cache memory 34 and the storage section 35, (which are included in the storage device 30), respectively. In the embodiment, the storage device 40 has the same functions as the storage device 30, and a description of the functions of the storage device 40 is omitted. Return to FIG. 1.

Hosts

The hosts 10 and 11 each access a virtual volume managed by the virtualization switch 20, and read data stored in the storage sections 35 and 45 of the storage devices 30 and 40 or write data in the storage devices 30 and 40. When the host 10 accesses the virtualization switch 20, the virtual volume is accessed by the host 10. A storage region of the virtual volume is associated with a storage region of at least one of the logical volumes. The host 10 can read or write data by accessing the virtual volume without detecting the configurations of the logical volumes. The virtualization switch 20 has setting information on the association of the virtual volume with the logical volume.

Management Device

The management device 50 is a terminal device that is used by an administrator to manage the entire storage system 1. The management device 50 sets allocations of virtual volumes according to an instruction from the administrator. The management device 50 transmits, to the virtualization switch 20, a command to perform a process of copying data between the virtual volumes specified in the instruction from the administrator.

Virtualization Switch

The virtualization switch 20 controls data communication between the hosts 10 and 11 and the multiple storage devices 30 and 40. The virtualization switch 20 is connected to the hosts 10 and 11 through communication lines such as fibre channels. In addition, the virtualization switch 20 is connected to the storage devices 30 and 40 through communication lines such as fibre channels.

The virtualization switch 20 includes one or more host interfaces 21 and 22, a processing section (processor) 23, a plurality of disk interfaces 25 and 26, and a memory 24.

The host interfaces 21 and 22 perform processes of receiving and transmitting various types of data from and to the hosts 10 and 11. In FIG. 1, the host interface 21 is connected to the host 10, while the host interface 22 is connected to the host 11.

The disk interfaces 25 and 26 performs processes of receiving and transmitting various types of data from and to the storage devices 30 and 40. In FIG. 1, the disk interface 25 is connected to the storage device 30, while the disk interface 26 is connected to the storage device 40.

The memory 24 and the processing section 23 are described below with reference to FIG. 1 and FIG. 2.

The memory 24 stores various types of programs that are used to cause the virtualization switch 20 to function. The memory 24 also stores various types of information that is used during the time when the processing section 23 executes at least one of the various types of programs. In addition, the memory 24 temporarily stores data to be copied during a process (described later) of copying the data between the storage devices.

The memory 24 stores, as mapping information, information on associations of the virtual volumes with the logical volumes. The mapping information is used to specify a physical volume to be actually accessed when a command to read data from the interested virtual volume or a command to write data in the interested virtual volume is received by the virtualization switch 20 from the host 10 or 11.

The memory 24 functions as a mapping information storage module 203 and a copy information storage module 204. The mapping information storage module 203 stores the mapping information that indicates the associations of the virtual volumes with the logical volumes. The copy information storage module 204 stores copy information.

The processing section 23 controls operations of the entire virtualization switch 20. The processing section 23 functions as a copy processing module 201 and a virtualization module 202 by executing the programs stored in the memory 24. The copy processing module 201 performs a process of copying data between the storage devices. The virtualization module 202 virtualizes the logical volumes of the storage devices.

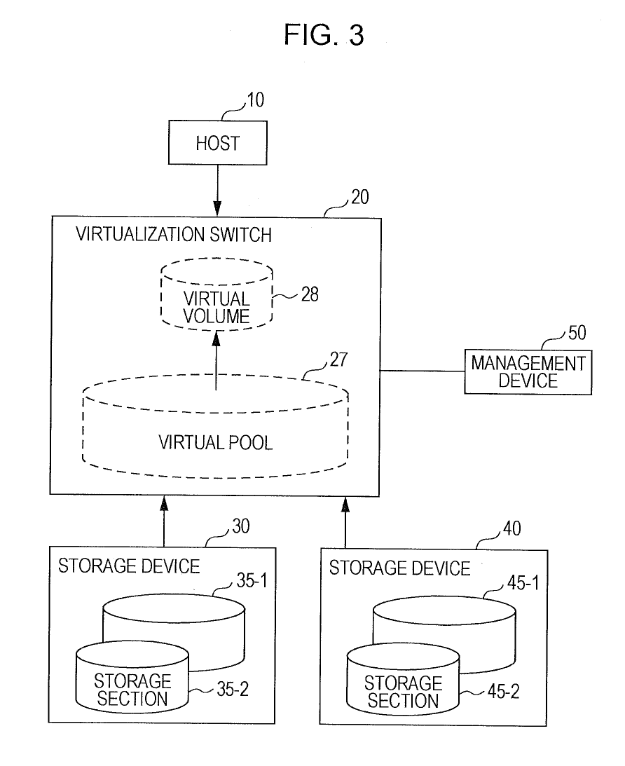

The virtualization function that is performed by the virtualization switch 20 is described below. FIG. 3 is a diagram illustrating virtualization of storage.

In the following description, a process of accessing the virtual volume of the virtualization switch 20 in order to read data from the virtual volume is performed by the host 10 or 11 and called a host reading process, while a process of accessing the virtual volume of the virtualization switch 20 in order to write data in the virtual volume is performed by the host 10 or 11 and called a host writing process. In addition, in the following description, a process of accessing the storage device 30 or 40 in order to read data from the storage device is performed by the virtualization switch 20 and called a reading process, while a process of accessing the storage device 30 or 40 in order to write data in the storage device is performed by the virtualization switch 20 and called a writing process.

In addition, in the following description, a command transmitted by the host 10 or 11 to instruct the virtualization switch 20 to perform the process of reading data from any of the virtual volumes of the virtualization switch 20 is called a host read command, while a command transmitted by the host 10 or 11 to instruct the virtualization switch 20 to perform the process of writing data in any of the virtual volumes of the virtualization switch 20 is called a host write command.

In addition, in the following description, a copying process includes the reading process and the writing process, and access indicates both access performed to read data stored in a virtual volume 28 and access performed to write data in the virtual volume 28.

The virtualization switch 20 sets the virtual volume 28 using storage sections 35-1, 35-2, 45-1 and 45-2 in the network layer (switch layer).

For example, the administrator operates the management device 50 so that the management device 50 transmits, to the virtualization switch 20, setting information on a virtual pool 27. The virtual pool 27 is formed by combining storage regions of the storage sections 35-1, 35-2, 45-1 and 45-2. The virtualization switch 20 sets the virtual volume 28 (not depending on the types of the storage sections) by appropriately selecting a storage region from among the storage regions set in the virtual pool 27. The virtualization switch 20 provides the set virtual volume 28 to the host 10 or 11.

The administrator can operate the management device 50 so that the management device 50 sets the number of virtual volumes, the capacity sizes of the virtual volumes, storage sections to be allocated, and the like. For example, the administrator operates the management device 50 so that the management device 50 transmits, to the virtualization switch 20, setting information that indicates a host to which the virtual volume 28 is allocated, the capacity size of the virtual volume 28, and the like. When the virtualization switch 20 receives the setting information on the virtual volume 28 from the management device 50, the virtualization switch 20 sets the virtual volume 28 on the basis of the setting information by combining one or more storage sections among the storage sections. The virtualization switch 20 allocates the set virtual volume 28 to the host. The virtual volume 28 is a storage region defined by combining one or more storage sections among the storage sections. It is assumed that the virtual volume 28 is a storage region defined by combining the storage regions of the storage sections 35-1 and 45-2. In addition, it is assumed that the virtual volume 28 is allocated to the host 10.

The virtualization module 202 causes the relationships between the virtual volume 28 and the storage sections 35-1 and 45-2 to be stored in the mapping information storage module 203 as the mapping information.

When the virtual volume 28 is accessed by the host 10, the virtualization module 202 references the mapping information stored in the mapping information storage module 203 and specifies the storage sections 35-1 and 45-2 that correspond to the virtual volume 28 accessed by the host 10.

As described above, the virtual volume 28 is formed by combining the storage regions of the storage sections 35-1 and 45-2. The storage section 35-1 is managed by the storage device 30, while the storage section 45-2 is managed by the storage device 40. The host 10 transmits, to the virtualization switch 20, a host read command to read data stored in the virtual volume 28. The host read command includes: information that specifies the virtual volume; information on the first address of the virtual volume from which the data is read; and the number of blocks from which the data is read.

The virtualization switch 20 references the mapping information and specifies, on the basis of the host read command, the storage section 35-1 and 45-2 that correspond to the virtual volume 28. The virtualization switch 20 specifies, on the basis of the mapping information, a storage section that stores data corresponding to the host read command. It is assumed that the storage section 35-1 has, stored therein, the data that corresponds to the host read command.

The virtualization switch 20 transmits a read command to the storage device 30 that manages the storage section 35-1.

The storage device 30 reads the data from the storage section 35-1 on the basis of the read command transmitted by the virtualization switch 20, and stores the read data in the cache memory 34. The storage device 30 transmits the read data to the virtualization switch 20.

When the virtualization switch 20 receives the data from the storage device 30, the virtualization switch 20 transmits the received data to the host 10.

In this manner, the virtualization switch 20 can virtualize the storage sections 35-1 and 35-2 (managed by the storage device 30) and the storage sections 45-1 and 45-2 (managed by the storage device 40). In addition, since the virtualization switch 20 manages the virtualization of the storage sections, the hosts 10 and 11 do not need to receive information on the configurations of the storage sections 35-1, 35-2 of the storage device 30 and information on the configurations of the storage sections 45-1 and 45-2 of the storage device 40.

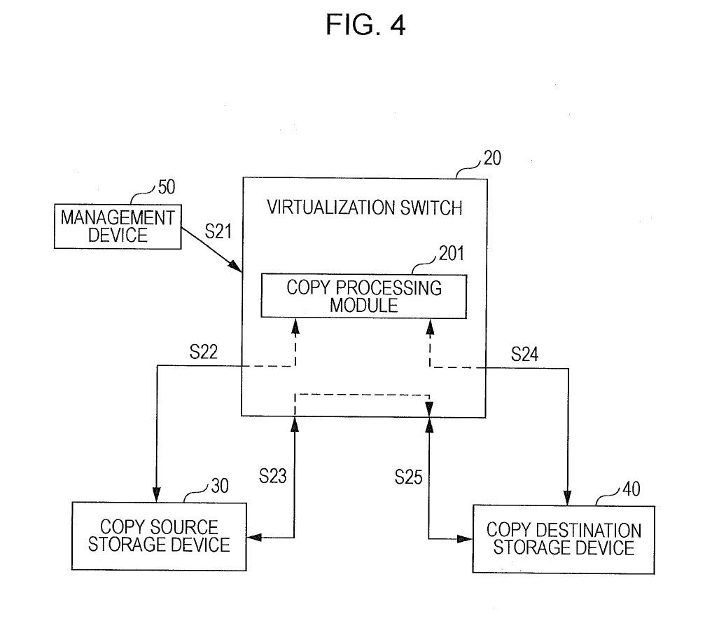

Next, a function of performing the process of copying data between the storage devices is described. FIG. 4 is a diagram illustrating the function of performing the process of copying data between the storage devices. The virtualization switch 20 has the function of performing the process of copying data between the storage devices without using CPUs included in the hosts 10 and 11 and memories included in the hosts 10 and 11.

In the following description, a copy source indicates a storage section that stores data (target data) to be copied; or a storage device that manages the storage section that stores the data to be copied, while a copy destination indicates a storage section in which the data that is stored in the copy source and to be copied is written; or a storage device that manages the storage section in which the data that is stored in the copy source and to be copied is written. In the embodiment, it is assumed that the copy source is the storage device 30 and the copy destination is the storage device 40. The storage device 30 manages a storage section that is the copy source, while the storage device 40 manages a storage section that is the copy destination.

The administrator operates the management device 50 so that the management device 50 transmits a copy command to the virtualization switch (in S21). The copy command is information that uses for the process of copying data between the storage devices. The copy command includes information that specifies the copy source; information that specifies the copy destination; and information that specifies the range of a storage region in which data is to be copied. The information that specifies the copy source is the address of the virtual volume of the copy source, while the information that specifies the copy destination is the address of the virtual volume of the copy destination. In the embodiment, the information specifying the copy source, the information specifying the copy destination, and the information specifying the range of the storage region in which the data is to be copied are intended for the virtual volumes. However, the information specifying the copy source, the information specifying the copy destination, and the information specifying the range of the storage region in which the data is to be copied may be intended for storage sections included in the storage devices.

When the virtualization switch 20 receives the copy command from the management device 50, the virtualization switch 20 references the mapping information and specifies a storage section (hereinafter referred to as copy source storage section) that corresponds to the information specifying the copy source. The virtualization switch 20 transmits a read command to the storage device 30 that manages the copy source storage section (in S22). The storage device 30 receives the read command and reads data corresponding to the read command from the storage section included in the storage device 30. The storage device 30 transmits the read data to the virtualization switch 20 (in S23). In this case, the storage device 30 stores the read data in the cache memory 34.

The virtualization switch 20 references the mapping information and specifies a storage section (hereinafter referred to as copy destination storage section) that corresponds to the information specifying the copy destination. The virtualization switch 20 transmits a write command to the storage device 40 that manages the copy destination storage section (in S24). In S24, the copy processing module 201 of the virtualization 20 transmits, to the copy destination storage device 40, information that allows the storage device 40 to determine whether or not the data corresponding to the write command needs to be stored in the cache memory 44 of the copy destination storage device 40. For example, when the virtualization switch 20 receives a copy command from the host 10, and data is to be copied between the storage devices or between logical volumes of the storage devices according to the copy command, the virtualization switch 20 determines that the data does not need to be stored in the cache memory 44 of the copy destination storage device 40.

The virtualization switch 20 transmits, to the copy destination, the data read from the copy source storage section as data to be written (in S25). In other words, the virtualization switch 20 transfers the data (that has been read from the storage device 30 and is to be written in the storage device 40) to the storage device 40 without adding information to the data.

In the embodiment, the virtualization switch 20 and the storage device 30 are connected to each other through the fibre channel, while the virtualization switch 20 and the storage device 40 are connected to each other through the fibre channel. Thus, a write command to write data to be transferred, a read command to read data to be transferred, and the data each have a header for a fibre channel protocol. The headers each include information on the identification of a device to which the interested data or command is transmitted. In addition, the header of the write command includes information on the identification of the write command, while the header of the read command includes information on the identification of the read command. The information on the identification of the write command and the information on the identification of the read command are represented by OX_ID. The storage devices each detect OX_ID of a command received by the storage device and perform a process according to the received command. Since S21 to S25 are performed, the virtualization switch 20 can perform the process of copying the data between the storage devices 30 and 40 without using the CPUs included in the hosts 10 and 11 and memories included in the hosts 10 and 11. The copying process is performed for mirroring or backup of data stored in the virtual volume.

In addition, a storage section that constitutes a single virtual volume may belong to multiple different storage devices. Thus, in order to copy data between virtual volumes, the data is copied from a first storage device to a second storage device, while the reading process and the writing process may be performed between the multiple storage devices.

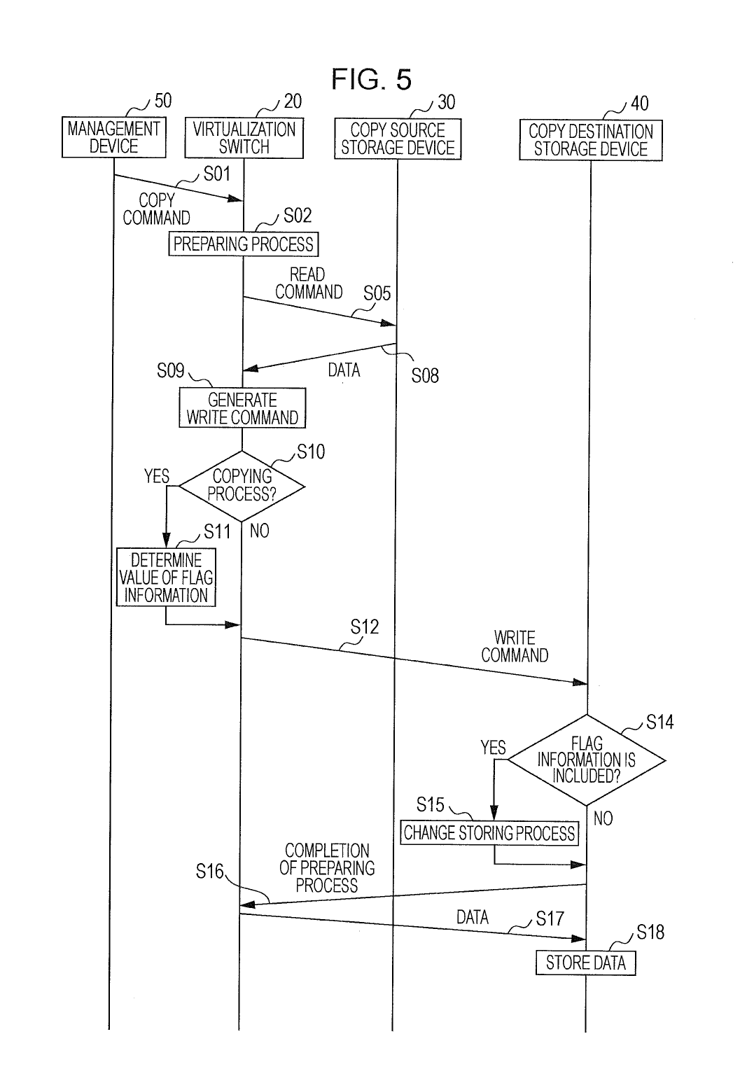

Next, the copying process according to the embodiment is described with reference to a flowchart of the copying process illustrated in FIG. 5. The embodiment describes that data stored in the storage source is copied to the storage destination in order to back up the data.

Copying Process Using Flag Information

The copying process in which flag information is added to a write command to be transmitted to the storage destination storage device is described below. The virtualization switch 20 according to the embodiment has a function of changing the value of flag information. The virtualization switch 20 determines whether or not the value of the flag information needs to be changed for each of write commands.

The flag information has a value “0” or “1”, for example. It is assumed that a write command that has, added thereto, flag information with a value “1” is a write command concerning data that is less likely to be read or written compared to other data, or that the write command that has, added thereto, the flag information with the value “1” is a write command concerning the process of copying between the storage devices. In addition, it is assumed that a write command that has, added thereto, flag information with a value “0” is a write command concerning data that is as likely or more likely to be read or written compared to other data, or that the write command that has, added thereto, the flag information with the value “0” is a normal write command. Therefore, the flag information with the value “1” indicates that the data is releasable from the cache memory of the copy destination storage device 40 or the copy source storage device 30.

In the embodiment, the virtualization switch 20 changes, to “1”, the value of the flag information added to a write command that instructs the copy destination storage device to write, in the cache memory of the copy destination storage device, data that is as likely or less likely to be read or written compared to other data. The data that is as likely or less likely to be read or written compared to the other data is data to be written for backup or mirroring of the data, e.g., is data to be written for copying between the virtual volumes. In other words, the virtualization switch 20 changes, to “1”, the value of the flag information added to the write command corresponding to the data to be copied, while the flag information with the value “1” indicates that the data is to be copied. In the embodiment, the storage device 40 manages the multiple storage sections, and it is assumed that the identification number of the copy destination storage section is “0008”.

The copy destination storage device 40 has a function of determining whether or not a write command has flag information. The cache management module 403 of the storage device 40 has a function of storing data in the cache memory 44 and deleting the data from the cache memory 44 after storing the data or has a function of preventing data from being stored in the cache memory 44 when the cache management module 403 receives the data that is to be written according to the flag information with the value changed to “1”.

The copying process is described with reference to the flowchart illustrated in FIG. 5.

The management device 50 transmits a copy command to the virtualization switch (in S01). In this copying process, all data stored in the virtual volume (hereinafter referred to as virtual copy source) of the copy source is copied to the virtual volume (hereinafter referred to as virtual copy destination) of the copy destination. The copy command includes information that identifies the virtual copy source; and information that identifies the virtual copy destination.

When the virtualization switch 20 receives the copy command, the virtualization switch 20 performs a copy preparing process (in S02). In the copy preparing process, the virtualization switch 20 specifies, from the mapping information, a storage section (copy source) corresponding to the virtual copy source and a storage section (copy destination) corresponding to the virtual copy destination. In addition, in the copy preparing process, the virtualization switch 20 suspends writing of data, except for writing of data in the copy destination in the copying process.

The virtualization switch 20 generates a read command for the copy source specified in S02. The virtualization switch 20 transmits the generated read command to the storage device 30 that has the copy source (in S05). The read command includes: information that identifies a storage section has, stored therein, data to be read; address information that specifies the first address of a region that is included in the storage section and in which the data to be read is stored; and the number of blocks from the first address of the region in which the data to be read is stored.

When the storage device 30 receives the read command transmitted by the virtualization switch in S05, the storage device 30 sequentially transmits, to the virtualization switch 20, data that corresponds to the read command (in S08).

As a preparing process, the storage device 30 may perform a process of storing, in the interested storage section, data stored in the cache memory 34, when necessary. When the storage device 30 performs the storing process as the preparing process, the cache memory 34 of the storage device 30 and the interested storage section have the same data stored therein.

The virtualization switch 20 generates a write command to be transmitted to the storage device 40 (in S09). In this case, the virtualization switch 20 generates the write command from the copy destination specified in S02. The write command includes: information that identifies a storage section that is included in the copy destination and in which data to be written is stored; address information that specifies on the first address of a region that is included in the storage section and in which the data to be written is stored; and the number of blocks from the first address of the region in which the data to be written is stored.

The virtualization switch 20 determines, on the basis of a command transmitted from the host 10 and received by the virtualization switch 20, whether or not the write command to be transmitted to the storage device 40 is a command to perform writing as a part of the process of copying between the virtual volumes (in S10). When the virtualization switch 20 determines that the write command is a command to perform writing as a part of the process of copying between the virtual volumes (Yes in S10), the virtualization switch 20 changes the value of the flag information added to the write command to “1” (in S11). After the value of the flag information added to the write command is changed to “1” in S11, the virtualization switch 20 transmits the write command to the storage device 40 (in S12).

When the virtualization switch 20 determines that the write command is not a command to perform writing as a part of the process of copying between the virtual volumes (No in S10), the virtualization switch 20 does not change the value of the flag information added to the write command to “1” and transmits the write command to the storage device 40 (in S12).

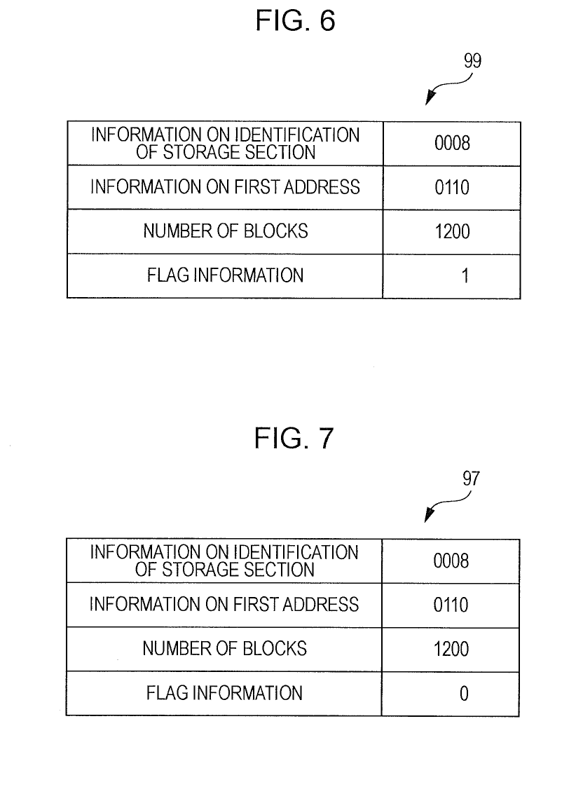

FIG. 6 illustrates an example of the write command that has the flag information with the value “1” and is indicated by reference numeral 99. In the write command 99 illustrated in FIG. 6, the information that identifies a storage section in which data to be written is stored indicates “0008”; the address information that specifies the first address of a region that is included in the storage section and in which the data to be written is stored indicates “0110”; the number of blocks from the first address of the region in which the data to be written is stored indicates “1200”; and the flag information indicates “1”.

FIG. 7 illustrates an example of the write command that has the flag information with the value “0” and is indicated by the reference numeral 97. In the write command 97 illustrated in FIG. 7, the information that identifies a storage section in which data to be written is stored indicates “0008”; the address information that specifies the first address of a region that is included in the storage section and in which the data to be written is stored indicates “0110”; the number of blocks from the first address of the region in which the data to be written is stored indicates “1200”; and the flag information indicates

The storage device 40 determines whether or not the received write command includes flag information (in S14). When the received write command includes flag information (Yes in S14), the storage device 40 changes a process of storing, in the cache memory 44, the data to be written (in S15). For example, when the storage device 40 detects flag information from the write command, the storage device 40 does not store the data corresponding to the write command in the cache memory 44 or performs a process of storing the data in the cache memory 44 and deleting the data from the cache memory 44 after writing of the data in the storage section 45. In addition, the storage device 40 may add, to the data corresponding to the write command, information indicating that the data is not used by an LCU, and the storage device 40 may store the data in the cache memory 44.

When the storage device 40 does not detect flag information from the write command (No in S14), the storage device 40 determines that the data is stored in the cache memory 44 since the write command is the normal write command.

After the storage device 40 completes a preparing process of performing S14 and S15, the storage device 40 transmits, to the virtualization switch 20, information that indicates the completion of the preparing process (in S16).

When the virtualization switch 20 receives, from the storage device 40, the information that indicates the completion of the preparing process, the virtualization switch 20 sequentially transmits, to the storage device 40, the data that has been received from the storage device 30 in S08 and corresponds to the write command (in S17).

When the storage device 40 receives, from the virtualization switch 20, the data corresponding to the write command that has the flag information added thereto, the storage device 40 stores the received data in the storage region determined in S14 and S15 (in S18). After the process of copying all the data is completed, the virtualization switch 20 releases the suspension (of writing of data) that has been set in the preparing process of performing S02 except for writing of data in the copy destination in the copying process.

As described above, when data is to be copied between the storage devices, the virtualization switch 20 adds, to a write command to be transmitted to the storage device 40, flag information that indicates that the data is to be deleted from the cache memory 44 on a priority basis. The storage device 40 can determine, on the basis of the flag information added to the write command, whether or not the data corresponding to the write command is to be stored in the cache memory 44 in a similar manner to normal data. The storage device 40 performs a process of preventing the data corresponding to the write command with the flag information added thereto from being stored in the cache memory 44 or performs a process of storing the data in the cache memory 44 and deleting the data from the cache memory 44 on a priority basis. As a result, the storage device 40 can delete, from the cache memory 44 on a priority basis, data (such as backup data) that will be less likely to be read in a short time period, and it is possible to effectively use the storage region of the cache memory 44 included in the storage device 40.

Copying Process Using Additional SCSI Command

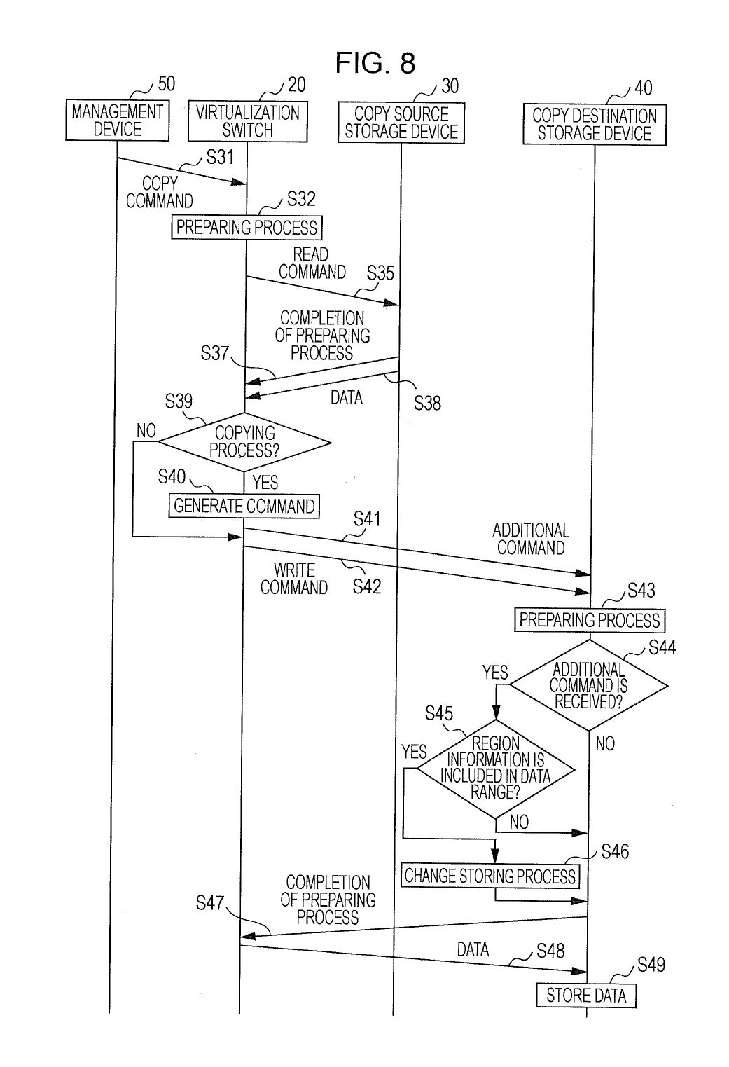

Next, a copying process using an additional process command in the storage system 1 is described. FIG. 8 is a flowchart of the copying process using the additional process command.

In order to perform the copying process, the storage system 1 has: a command (hereinafter referred to as additional command) to specify the range of data that is not stored in the cache memory of the storage device or is stored with a priority that is lower than a priority of other data; and a command (hereinafter referred to as release command) to release the specification of the range of the data that is not stored in the cache memory of the storage device.

The copying process is described below with reference to the flowchart illustrated in FIG. 8.

The management device 50 transmits a copy command to the virtualization switch 20 (in S31). In this copying process, all data stored in the virtual volume (hereinafter referred to as virtual copy source) of the copy source is copied to the virtual volume (hereinafter referred to as virtual copy destination) of the copy destination. The copy command includes information that identifies the virtual copy source; and information that identifies the virtual copy destination.

When the virtualization switch 20 receives the copy command transmitted in S31, the virtualization switch 20 performs a copy preparing process (in S32). In the copy preparing process, the virtualization switch 20 specifies, from the mapping information, a storage section (copy source) corresponding to the virtual copy source and a storage section (copy destination) corresponding to the virtual copy destination. In addition, in the copy preparing process, the virtualization switch 20 suspends writing of data, except for writing of data in the copy destination in the copying process.

The virtualization switch 20 generates a read command for the copy source specified in S32. The virtualization switch 20 transmits the generated read command to the storage device 30 that has the copy source (in S35). The read command includes: information that identifies a storage section that has, stored therein, data to be read; address information that specifies the first address of a region that is included in the storage section and in which the data to be read is stored; and the number of blocks from the first address of the region in which the data to be read is stored.

As a preparing process, the storage device 30 may perform a process of storing, in the interested storage section, data stored in the cache memory 34, when necessary. When the storage device 30 performs the storing process as the preparing process, the cache memory 34 of the storage device 30 and the interested storage section have the same data stored therein.

When the storage device 30 receives the read command from the virtualization switch 20, the storage device 30 transmits, to the virtualization switch 20, information that indicates completion of the copy preparing process (in S37). After the storage device 30 transmits the information that indicates the completion of the copy preparing process, the storage device 30 sequentially transmits, to the virtualization switch 20, data corresponding to the read command (in S38).

The virtualization switch 20 determines whether or not a write command to be transmitted to the storage device 40 is a command to perform writing as a part of the process of copying between the virtual volumes (in S39). When the write command is a command to perform writing as a part of the process of copying between the virtual volumes (Yes in S39), the virtualization switch 20 generates an additional command (in S40). The virtualization switch 20 transmits the additional command generated in S40 to the storage device 40 (in S41).

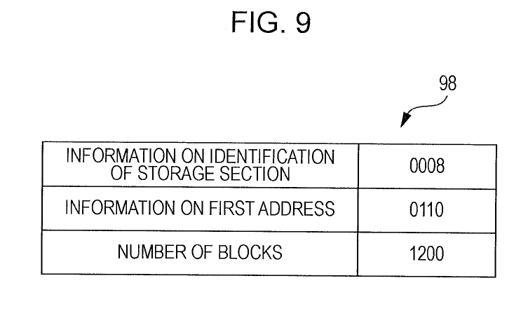

The virtualization switch 20 determines, on the basis of a command transmitted from the host and received by the virtualization switch 20, whether the write command to be issued is a command to perform writing as a part of the process of copying between the virtual volumes or a command to simply perform writing of data. When the write command to be issued is a command to perform writing as a part of the process of copying between the virtual volumes, data that is included in a data range indicated by the write command will be less likely to be used in the near future. Thus, the virtualization switch 20 generates an additional command to reduce a priority for storing, in the cache memory 44, the data that is included in the data range indicated by the write command so that the priority is lower than a priority of other data stored in the cache memory 44. The additional command includes: information that identifies a storage section; address information that specifies the first address of an interested region included in the storage section; and the number of blocks from the first address of the interested region. FIG. 9 illustrates an example of the additional command indicated by reference numeral 98. In the additional command 98, the information that identifies the storage section indicates “0008”; the address information that specifies the first address of the interested region included in the storage section indicates “0010”; and the number of blocks from the first address of the interested region is “1200”.

The storage device 40 can specifies, from the information included in the additional command, the range of data that is not to be stored in the cache memory 44. In addition, the storage device 40 can reduce a priority for storing, in the cache memory 44, data corresponding to the range specified in the additional command so that the priority is lower than a priority of other data stored in the cache memory 44.

When the write command is not a command to perform writing as a part of the process of copying between the virtual volumes (No in S39), the virtualization switch 20 transmits the write command to the storage device 40 (in S42) after transmitting the additional command in S41. The write command includes: information that identifies a storage section that is included in the copy source and in which data to be written is stored; address information that specifies the first address of a region that is included in the storage section and in which the data to be written is stored; and the number of blocks from the first address of the region in which the data to be written is stored. Thus, the write command specifies information on the region in which the data is to be written. The virtualization switch 20 may simultaneously transmits the write command and the additional command.

When the storage device 40 receives the write command transmitted by the virtualization switch 20 in S42, the storage device 40 performs a preparing process (in S43). In the preparing process, the storage device 40 stores, in the interested storage device 45, data stored in the cache memory 44. When the storage device 40 performs the preparing process, the cache memory 44 of the storage device 40 and the storage section 45 have the same data stored therein.

In addition, the storage device 40 determines whether or not the storage device 40 receives the additional command transmitted in S41 (in S44). When the storage device 40 receives the additional command transmitted in S41 (Yes in S44), the storage device 40 determines whether or not the region information indicated by the write command is included in the data range specified by the additional command (in S45). When the data range indicated by the write command transmitted in S42 is included in the data range specified by the additional command transmitted in S41 (Yes in S45), the storage device 40 changes a process of storing, in the cache memory 44, the data to be written (in S46). For example, the storage device 40 does not store the data (to be written according to the write command) in the cache memory 44, or stores the data (to be written according to the write command) in the cache memory 44 and deletes the data from the cache memory 44 after storing the data in the storage section 45, or stores the data (to be written according to the write command) in the cache memory 44 and adds, to the data, information that allows the data to be deleted from the cache memory 44 after storing the data in the storage section 45.

When the storage device 40 does not receives the additional command transmitted in S41 (No in S44), or when the data range indicated by the write command transmitted in S42 is not included in the data range specified by the additional command transmitted in S41 (No in S45), the storage device 40 treats the write command as the normal write command and performs a storing process on the data in a similar manner to data to be written according to the normal write command. For example, the storage device 40 determines that the data to be written is stored in the cache memory 44.

When the storage device 40 completes the preparing process of performing S43 to S46, the storage device 40 transmits, to the virtualization switch 20, information that indicates the completion of the preparing process (in S47).

When the virtualization switch 20 receives, from the storage device 40, the information that indicates the completion of the preparing process, the virtualization switch 20 sequentially transmits, to the storage device 40, the data corresponding to the write command (in S48).

In S48, the virtualization switch 20 sequentially transmits, to the storage device 40, the data received from the storage device 30 in S38. When the storage device 40 receives, from the virtualization switch 20, the data to be written, the storage device 40 stores the received data in the cache memory 44 or the storage section 45 according to the storing process changed in S46 (in S49).

After the process of copying between the storage devices, the virtualization switch 20 transmits, to the copy destination storage device 40, a command to release the specification of the range of the data that is not to be stored in the cache memory 44. However, the virtualization switch 20 may transmit, to the copy destination storage device 40, the command to release the specification of the data range after completion of a process that is related to the storage section of the copy destination and included in the process of copying between the storage devices.

In the storage system disclosed above, since the virtualization switch 20 transmits, to a copy destination storage device, information that indicates whether or not to store data corresponding to a write command in a cache memory, the copy destination storage device can reduce a priority for storing the data in the cache memory. As a result, it is possible to prevent unnecessary data from being accumulated in the cache memory of the copy destination storage device, and it is possible to improve accessibility to the storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

1. A switch device comprising:
a first interface connected to a first storage device for transmitting data to and receiving data from the first storage device;
a second interface connected to a second storage device having a cache memory, for transmitting data to and receiving data from the second device;
a third interface connected to an external device, for transmitting data to and receiving data from the external device; and
a processor executing:
receiving a copy command indicating to copy target data stored in the first storage device to the second storage device from the external device via the third interface,
transmitting a reading out command indicating to read out the target data stored in the first storage device corresponding to the copy command to the first storage device via the first interface,
receiving from the first storage device via the first interface the target data corresponding to the transmitted reading out command, and
transmitting to the second storage device via the second interface a writing command for writing the target data and release information indicating that the target data is releasable from the cache memory.

2. The switch device according to claim 1, wherein the first storage device has a first cache memory, wherein
the processor transmits to the first storage device via the first interface the reading out command and second release information indicating that the target data stored in the first storage device is releasable from the first cache memory.

3. The switch device according to claim 1, wherein the release information includes range information indicates range of the data.

4. The switch device according to claim 1, wherein the processor transmits to the second storage device via the second interface the release information before transmitting the writing command.

5. The switch device according to claims 1,
wherein the processor further executes managing a first virtual volume formed by volumes of the first storage device and a second virtual volume formed by volumes of the second storage device,
wherein the copy command includes information indicating to store the target data stored in the first virtual volume into the second virtual volume.

6. A method for controlling a switch device connected to a host, a first storage device, and a second storage device having a cache memory, the method comprising:
receiving, by the switch device, a copy command indicating to copy target data stored in the first storage device to the second storage device from the host,
transmitting a reading out command indicating to read out the target data stored in the first storage device corresponding to the copy command to the first storage device,
receiving the target data corresponding to the transmitted reading out command from the first storage device, and
transmitting, to the second storage device, a writing command for writing the target data and release information indicating that the target data is releasable from the cache memory.

7. The method according to claim 6, wherein the first storage device has a first cache memory, the method further comprising transmitting second release information indicating that the target data stored in the first storage device is releasable from the first cache memory upon transmitting the reading out command.

8. The method according to claim 6, wherein the release information includes range information indicating range of the data.

9. The method according to claims 6, further comprising managing a virtual volume formed by using volumes of the first storage device and the second storage device, wherein the copy command includes first volume information indicating a virtual volume of the first storage device and second volume information indicating a virtual volume of the second storage device.

10. A system connectable to a host, comprising:
a switch device;
a first storage device; and
a second storage device including
a storage module for storing data, and
a cache memory for temporarily storing the data to be written into the storage module,
wherein the switch device executes:
receiving a copy command indicating to copy target data stored in the first storage device to the second storage device from the host,
transmitting a reading out command indicating to read out the target data stored in the first storage device corresponding to the copy command to the first storage device,
receiving the target data corresponding to the transmitted reading out command from the first storage device, and
transmitting, to the second storage device, a writing command for writing the target data and release information indicating that the target data is releasable from the cache memory,
wherein the second storage device executes:
storing the target data to the cache memory,
storing the target data to the storage module, and releasing the target data stored in the cache memory preferentially from other data stored in the cache memory upon receiving the release information and the target data is stored in the storage module.

11. A storage device comprising:
a storage module for storing data;
a cache memory for temporary storing data to be written into the storage module; and
a processor executing:
storing the data to the cache memory,
storing the data to the storage module, and
releasing the data stored in the cache memory preferentially from other data stored in the cache memory upon receiving release information and the target data is stored in the storage module.
